(19) United States
(12) Patent Application Publication
(10) Pub. No.: US 2023/0313750 A1
(43) Pub. Date: Oct. 5, 2023

(54) HYDROGEN ENGINE ACTIVE CRANKCASE VENTILATION SYSTEM FOR MOISTURE REMOVAL AND EXPLOSION MITIGATION

(71) Applicants: Hailin Li, Morgantown, WV (US); Harold Sun, West Bloomfield, MI (US)

(72) Inventors: Hailin Li, Morgantown, WV (US); Harold Sun, West Bloomfield, MI (US)

(21) Appl. No.: 18/129,303

(22) Filed: Mar. 31, 2023

Related U.S. Application Data
(60) Provisional application No. 63/326,445, filed on Apr. 1, 2022.

(51) Int. Cl. F02D 41/00; F01M 13/00; F01M 13/02; F01M 13/04

(52) U.S. Cl. CPC F02D 41/0052; F01M 13/0011; F01M 13/028; F01M 13/04; F02D 41/0077; F02D 2200/70

(57) ABSTRACT

Various examples are provided related to crankcase ventilation for moisture removal and explosion mitigation. In one example, a combustion engine includes a crankcase with a combustion chamber; a crankcase vent for venting crankcase gas from the crankcase; and an active crankcase ventilation system for supplying supplemental air to the crankcase. The crankcase gas can include a mixture of blowby gas from the combustion chamber and the supplemental air in a ratio that reduces or eliminates condensation of water in the crankcase gas. The combustion engine can be a hydrogen engine or other type of engine.

### CROSS REFERENCE TO RELATED APPLICATIONS

This application claims priority to, and the benefit of, co-pending U.S. provisional application entitled “Hydrogen Engine Active Crankcase Ventilation System for Moisture Removal and Explosion Mitigation” having Ser. No. 63/326,445, filed Apr. 1, 2022, which is hereby incorporated by reference in its entirety.

### BACKGROUND

The combustion products of hydrogen (H₂) fueled internal combustion engines contain a high percentage of moisture. Blowby gas entering the hydrogen engine crankcase is a mixture of unburned H₂, air, nitrogen oxides (NOₓ), water vapor, and other burned combustion products. The moisture entering the crankcase with blowby may condense to liquid water which can contaminate the lubrication oil, negatively affecting the oil's lubricity, and ultimately damaging engine components. The presence of H₂ and oxygen (O₂) gas in the crankcase raises safety concerns due to a higher risk for explosion if ignited.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of conventional passive crankcase ventilation on an engine, in accordance with various embodiments of the present disclosure.

FIG. 2 illustrates an example of an active crankcase ventilation system on an engine, in accordance with various embodiments of the present disclosure.

FIG. 3 is a flowchart illustrating an example of operation of the active crankcase ventilation system of FIG. 2, in accordance with various embodiments of the present disclosure.

### DETAILED DESCRIPTION

Disclosed herein are various examples related to crankcase ventilation for moisture removal and explosion mitigation. An active or forced crankcase ventilation system for hydrogen engines can mitigate the formation of liquid water and the flammable hydrogen-oxygen mixture present in the crankcase. The ventilation system can remove moisture from the crankcase by providing extra air to dilute the water moisture present in the crankcase below the saturation point to avoid its condensation to liquid water. The additional air entering the crankcase can dilute the hydrogen-oxygen mixture below the lean flammability limit, so the diluted hydrogen-air-oil vapor mixture remains inflammable and safe. The active or forced crankcase ventilation system can also be applied to other engines for the removal of water moisture and combustible bulk mixture formed in the crankcase. Reference will now be made in detail to the description of the embodiments as illustrated in the drawings, wherein like reference numbers indicate like parts throughout the several views. Alternatively, a passive moisture absorption coating with high porosity ceramic materials can be applied to crankcase metal walls to absorb condensation at low temperatures to prevent the condensation water from contaminating lubricant in the oil pan, and the condensation can evaporate at higher temperatures. Maintaining high water moisture in the crankcase without condensation at elevated wall temperature can effectively increase the lower flammability limit of hydrogen and prevent the hydrogen contained in the crankcase from being ignited to a certain degree even without forced crankcase ventilation. The passive moisture absorption can be very helpful as the water condensation may occur when the engine is shut down, engine control and forced ventilation are powered off and metal surface temperature cools down. High porosity materials can include, e.g., silica aerogel, ceramic foam, and zirconia-based ceramic coatings. These materials have high surface areas and excellent thermal insulating properties, which allow them to capture moisture and release it back into the crankcase ventilation when the engine crankcase wall temperature rises to further participate in the engine combustion and mitigation of NOₓ emission when recirculated back into cylinder through intake system. These materials can be applied using a variety of coating techniques, including thermal spraying, dip coating, and electrostatic deposition.

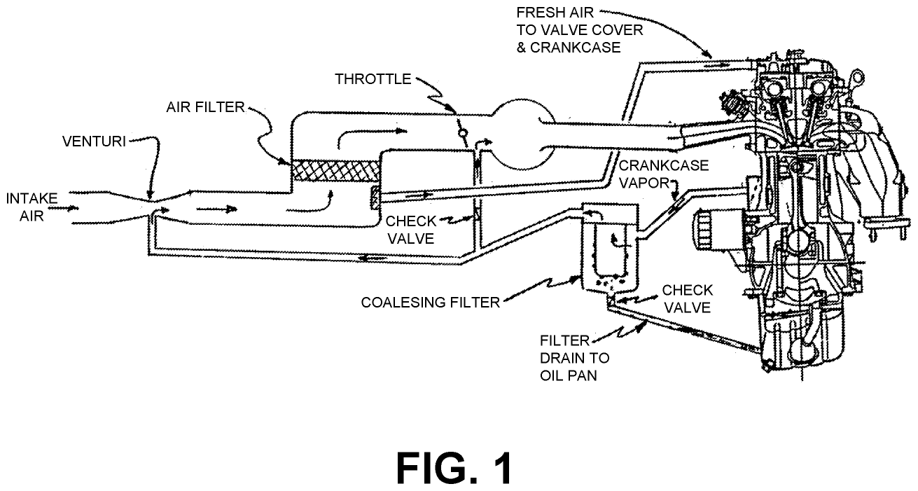

Referring to FIG. 1, shown is an example of conventional passive crankcase ventilation that relies on the vacuum in the throat area of a venturi or right after inlet throttle to vent the hydrogen and water contained moisture out of crankcase into the air inlet system. Such a system is able to eliminate the leakage of blowby gas into ambient air and associated emissions of unburned fuel such as hydrogen, carbon monoxide, and others. The blowby gas of the internal combustion engine is currently removed by a positive crankcase ventilation (PCV) valve (or a vacuum pump for plug-in electric hybrid vehicles or hydrogen engines). Once the pressure in crankcase is built-up due to blowby, the PCV valve opens and the gas mixture in the crankcase is purged into the intake manifold of the internal combustion engine. A coalescing filter or oil separator can be installed to remove the lubrication oil from the blowby gas. However, such a system cannot prevent or eliminate the formation of liquid water in the lubrication oil by condensation of water moisture prior to the blowby gas being removed from crankcase especially when temperature in the crankcase is low such as that observed during the cold start process.

The presence of unburned hydrogen and oxygen in the blowby gas also raises safety concerns for its very wide flammability region and low ignition energy. The PCV valve (or the vacuum pump) in the conventional passive crankcase ventilation can vent the blow-by gas and reduce the content of the mixture in the crankcase but cannot dilute the H₂ concentration below the lean flammable level and keeping the gas mixture safe from combustion or explosion.

An active crankcase ventilation system has been developed that provides extra air from an external source which can dilute the blowby gas in the crankcase and have it vented into engine intake system through active ventilation. In this system, the condensation of moisture in the crankcase can be eliminated by providing the external air to dilute the water moisture in the crankcase so that it will not condense to liquid water in crankcase prior to its removal. The water condensation is a function of the temperature and partial pressure of water vapor. Forced ventilation or dilution can reduce the partial pressure of water vapor thus mitigating water condensation.

The extra air can also diluent the H₂ concentration in the blowby gas mixture below the lean flammability limit, making it a non-flammable, non-explosive mixture. The diluted blow-by gas and air mixture can be vented from the crankcase into an intake system by creating a pressure difference between dilution air and intake system. For example, such a system can be applied to a naturally aspirated H₂ engine with a pressure difference created by a vacuum in the intake manifold. It can also be applied to, e.g., a H₂ engine with boosted intake pressure, such as supercharged or turbocharged H₂ engine. The disclosed system can effectively eliminate or at least minimize the condensation of moisture in crankcase and mitigate the explosion hazard in the crankcase of hydrogen engines.

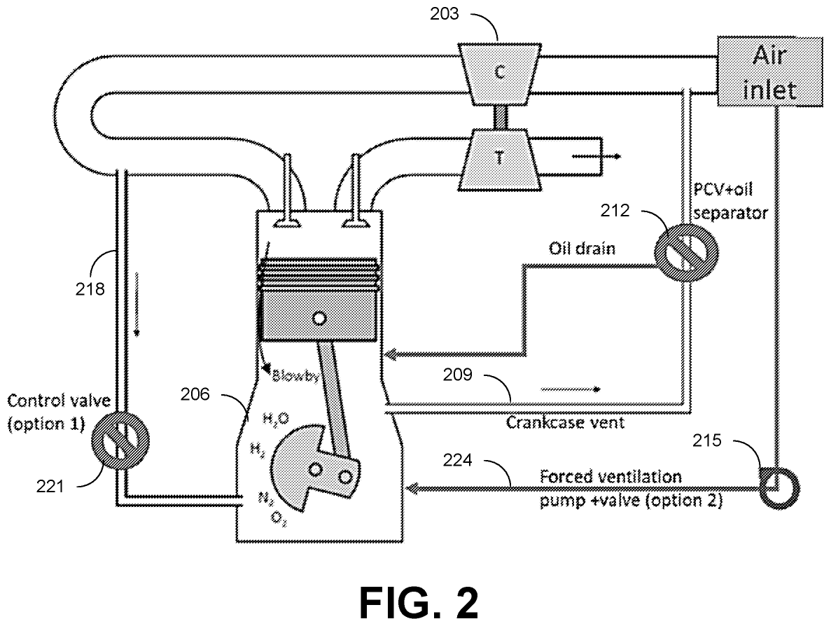

Referring to FIG. 2, shown in an example of the active crankcase ventilation system used with a turbocharged hydrogen engine. Typical hydrogen engines are boosted to achieve high power density with lean combustion for low NOₓ emission. In the example of FIG. 2, the turbocharged hydrogen engine comprises a turbine-driven compressor (e.g., a turbocharger) or supercharger 203 that compresses gas from the air inlet to supply the hydrogen engine for combustion. Discharged gas from the engine is exhausted through the turbine to drive the compressor. As illustrated in FIG. 2, blowby gas around a piston can enter the crankcase 206 during operation of the hydrogen engine. A crankcase vent 209 allows the blowby gases to exit the crankcase 206 and be directed back to the air inlet through a PCV valve. The PCV valve can be configured to provide a higher flow rate (e.g., greater than 1-2% of total air flow through the cylinders) than those valves used in conventional passive crankcase ventilation. The vented crankcase gas can enter the compressor inlet for combustion in the cylinder, or can enter the intake manifold, downstream of an intake throttle that can operate in a throttling mode for light load conditions. An oil separator 212 can be included to separate the oil mist in the vented mixture to minimize and/or eliminate fouling on compressor blades in the intake system, etc. The oil separator 212 can be passive (e.g. coalescing filter) or active (e.g. mechanically or electrically driven centrifugal separator). The separator can be integrated with a PCV. The PCV may have electric heating to prevent water condensation or icing within PCV.

The pressurized source of the supplemental ventilation can be, e.g., the outlet of single or multi-stage compressor, supercharger 203 or an outlet of an electrical or mechanical driven standalone air pump 215 (e.g. mechanically or electrically driven centrifugal compressor, gear pump, screw pump, etc.). In an intake pressure boosted engine, a pressure difference is established between the high pressure after the compressor 203 and the low pressure at the compressor inlet. For a natural aspirated hydrogen engine, the pressure differential will rely on the electrical or mechanical driven standalone air pump 215 or the vacuum developed by the intake system. A supplemental ventilation supply 218 (e.g., piping or tubing) can include a control valve 221 configured to control the flow rate of the supplemental (or diluting) air entering the crankcase 206. In some implementations (e.g., for a natural aspirated hydrogen engine), supplemental air can also be supplied to the crankcase 206 by an air pump 215 through a supplemental air supply system 224. The supplemental air supply system 224 can include a control valve (not shown) configured to control the flow rate of the supplemental air entering the crankcase 206 and/or the air pump 215 can be configured to vary its speed to control the flow rate of the supplemental air entering the crankcase 206. The supplemental air is supplied to the crankcase 206 to dilute the moisture and hydrogen in the crankcase. The mixing of the extra diluting air with the blowby gas can ensure a condensation-free crankcase while keeping the resultant mixture inflammable. The active crankcase ventilation system and PCV valves can be configured to supply supplemental air into the crankcase 206 without producing a positive pressure (e.g., 0.2-0.5 bar or greater) above ambient air pressure, benefiting from gases in the crankcase being removed by a vacuum.

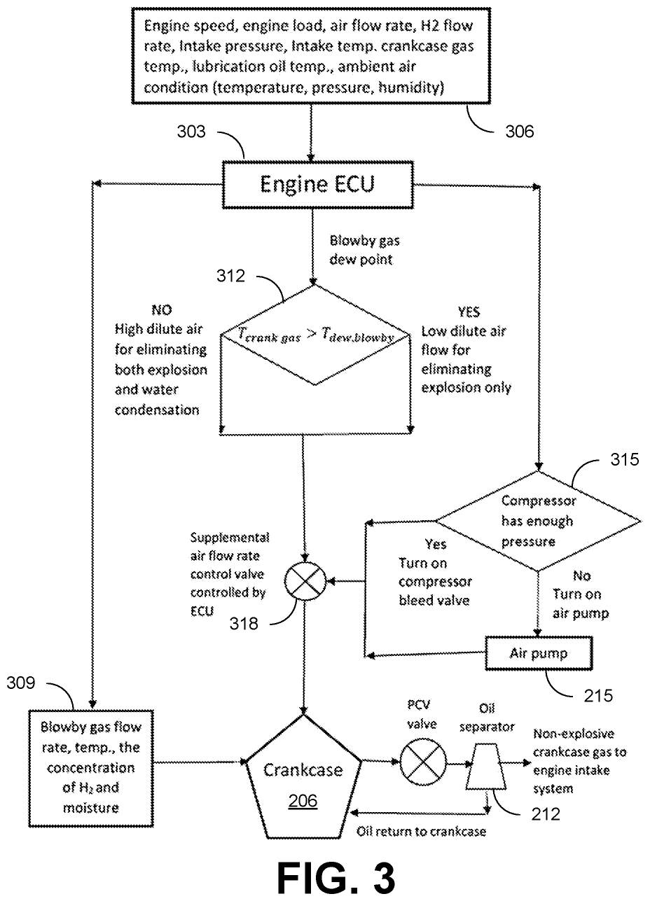

FIG. 3 is a flowchart illustrating an example of the operation of the active crankcase ventilation system for a hydrogen engine. An engine electronic control unit (ECU) 303 comprising processing circuitry (e.g., a processor and memory) can receive various engine parameters 306 (e.g., equivalence ratio, ambient air temperature and relative humidity, etc.) and determine the flow rate, concentration of hydrogen and moisture, and/or saturation temperature of the blowby gas entering crankcase 206 (FIG. 2) at 309. Pressure and temperature sensing in the crankcase can be used to monitor the crankcase pressure and temperature to monitor the health of piston ring pack, the oil/gas separator and PCV valve. Supplemental diluting air can be provided to the crankcase 206 (1) to eliminate a hydrogen explosion hazard by diluting hydrogen in crankcase 206 below the low flammability limit and (2) to eliminate the condensation of water in crankcase 206 by decreasing the dew point of crankcase gas below the crankcase gas temperature through dilution of the moisture concentration in crankcase 206. The amount of supplemental air for elimination of the moisture condensation is usually more than the supplemental air needed for hydrogen explosion elimination.

As shown in FIG. 3, the temperatures of crankcase gas (T_{crank gas}) and dew point of blowby gas (T_{dew,blowby}) can be used to determine whether the moisture will condense or not. When the temperature of the crankcase gas (T_{crank gas}) is higher than the dew point of blowby gas (T_{dew,blowby}) at 312, the moisture will not condense in crankcase so supplemental air is only provided for eliminating hydrogen explosion. In comparison, when the crankcase gas temperature is lower than the dew point of blowby gas at 312, a higher supplemental air flow rate is needed to eliminate the condensation of water. When the passive moisture absorption ceramic coating is applied on the crankcase component metal surfaces, the threshold dew point temperature below which the supplemental air forced flow will be turned on may be adjusted accordingly at 312, based on the porosity and specific surface area of the ceramic coatings.

The supplemental air can be supplied by either the compressor of turbocharger (intake air booster) 203 and/or a dedicated air pump 215 as shown in FIG. 2. For example, the air pressure after the compressor of the turbocharger (intake air booter) 203 can be determined at 315. If the air pressure after the compressor is higher than that needed to supply the desired supplemental air, then the supplemental air can be supplied by the compressor (intake air booster). If not (as in the case of, e.g., a natural aspirated hydrogen engine), then supplemental air can be supplied by the dedicated air pump 215 or a vacuum in the intake system.

The aforementioned forced crankcase ventilation for hydrogen accumulation and water condensation can be combined with a “passive” moisture control in the crankcase, e.g., a passive moisture absorption coating with high porosity ceramic materials can be applied to crankcase metal walls to absorb condensation at low temperatures to prevent the condensation water from contaminating lubricant in the oil pan, and allow the condensation to evaporate at higher temperatures. This can reduce the forced ventilation air flow and maintain near saturated water moisture in the crankcase. Maintaining near saturated water moisture in the crankcase without condensation at elevated wall temperature can effectively increase the lower flammability limit of hydrogen and prevent the hydrogen contained in the crankcase from being ignited to a certain degree even without forced crankcase ventilation. High porosity materials can include, but are not limited to, silica aerogel, ceramic foam, and zirconia-based ceramic coatings. These materials have high specific surface areas and excellent thermal insulating properties, which allow them to capture moisture and release it back into the crankcase ventilation when the engine crankcase wall temperature rises to further participate in the engine combustion and mitigation of NOₓ emission. These materials can be applied using a variety of coating techniques, including thermal spraying, dip coating, and electrostatic deposition.

Based on the crankcase material, for better adhesion high porosity top layer materials that can be used include, e.g., silica aerogel, ceramic foam, and zirconia-based or alumina based ceramic coatings. The thickness of the top high porosity coating can be about 20 μm to about 100 μm. The porosity of the top ceramic moisture absorption coating can be about 10% to about 35%. Based on the crankcase material, the passive moisture absorption coating can utilize a bonding layer to match the thermal expansion coefficient and maximize the adhesion with the base metal. The bonding layer can comprise, but is not limited to, aluminum, composite magnesium aluminum alloy, cast iron or various other alloys. For example, the bonding layer material can be MCrAIY. The thickness of the bonding layer can be about 10 μm to about 200 μm and the porosity of the bonding layer coating can be about 2% to about 5%. These high porosity materials can be applied on the component surfaces inside the crankcase using a variety of coating techniques including, e.g., thermal spraying or plasma spraying, brush or roll coating, dip coating, physical or chemical vapor deposition, and electrostatic deposition.

The flow rate of the supplemental air can be controlled by the control valve in supply 218 or 224. The position of the supplemental air control valve can be controlled by engine ECU 303. The PCV valve and oil separator 212 can control the pressure in crankcase 206 and separate lubrication oil vapor from the crankcase gas (a mixture of blowby gas and supplemental air). The oil recovered can flow back to crankcase 206. The non-explosive oil free crankcase gas exiting from PCV valve can be provided to the engine intake system. Hydrogen in the blowby gas is eventually burned in the engine combustion chamber. The near saturated moisture that is vented back into engine will help mitigate NOₓ emissions, slow down the hydrogen combustion and lower the flame temperature and combustion speed.

Examination Results of One Application

A preliminary examination of one application of the active crankcase ventilation system was carried out (1) to examine the possibility of forming combustible mixture and water condensation in the crankcase of a SI hydrogen engine; (2) to examine the feasibility of the active crankcase ventilation in mitigating water condensation and explosion hazard in the crankcase of a SI hydrogen engine; (3) to estimate the flow rate of supplemental air needed in diluting blowby gas to form inflammable hydrogen containing mixture and mitigating the condensation of water in crankcase. A 2-liter turbocharged SI hydrogen engine was utilized in the examination. A crankcase volume of 10 liters was estimated by assuming 5 times of engine displacement. The SI hydrogen engine operates on an equivalence ratio (ER)=0.5, or 50% of hydrogen compared to that of stoichiometric mixture of hydrogen in air. The engine cold start idle operation was set at 1 bar intake pressure, 600 rpm, and 40% charging efficiency, 2 minutes and the cruise operation after cold start idle was at 1.5 bar intake pressure, 2500 rpm, 80% charging efficiency, 8 minutes.

For the examination, the blowby flow rate was assumed as 1% of engine flow rate. Based on engine research experience, the blowby gas was estimated as 50% fresh intake mixture consisting air and hydrogen (ER=0.5 as assumed), and 50% combustion products consisting of water (H₂O), N₂, excess O₂ and a very small amount of unburned H₂ which is neglected in this estimation. The composition of the blowby gas was estimated as: 9.51% H₂O, 8.68% H₂, 13.44% O₂, and 68.38% N₂. A detailed explanation to the estimation of the blowby gas composition can be found in the Appendix I below.

The lean flammability of hydrogen in air was 4%. The estimated hydrogen percentage in the fresh blowby gas was 8.68%, which is well above the 4% lean flammability limit of hydrogen in air. The presence of moisture and extra N₂ in the blowby gas beyond that in air will work as a diluent and slightly affect the lean operational limit. However, the thermal capacity of water moisture is to some extent comparable to that N₂ or between N₂ and CO₂. Based on fundamental knowledge of the flammability limit, the blowby gas of a hydrogen engine operated on ER of 0.5 is explosive or able to support the propagation of flame in crankcase if ignited. It should be noted that the presence of the oil vapor in the crankcase will make the crankcase explosion hazard even worse. The dilution of the blowby gas in the crankcase can eliminate the explosion hazard in hydrogen engine crankcase.

The mixing of the supplemental air using the active crankcase ventilation system provides extra air, diluting the blowby gas and decreasing the concentration of H₂ below the low flammability limit. With the assumed 4% low flammability limit of hydrogen and the estimated 8.68% H₂ in the blowby gas, the minimum supplemental air needed to mitigate the explosion hazard is 1.17 times that of the maximum blowby flow rate possible for this engine. The detailed method used for estimating the supplemental air needed for eliminating explosion hazard in crankcase is shown in Appendix II below.

The dew point of the blowby gas with a composition of 9.51% H₂O was estimated as 44.8° C. Considering the ambient air temperature (usually cooler than 44.8° C.) and changes in oil temperature during engine cold start operation, it was estimated that part of the moisture entering engine crankcase with the blowby gas will condense to liquid water and accumulate in engine oil. The lower the ambient air temperature and crankcase oil temperature, the more moisture condenses in crankcase. Based on fundamental knowledge of water vapor properties, engine operating conditions, and operation principles of the traditional crankcase PCV valves, it was estimated that water condensation will occur during the cold start process prior to the temperature of the crankcase and/or oil reaching 44.8° C. which varies with the change in engine operating conditions noted as equivalence ratio. Most of the moisture residue in the crankcase after the engine is turned off will also eventually condense to liquid water as the crankcase and lubrication oil will eventually be cooled to ambient air temperature. In this case, the passive moisture absorption ceramic coating on the metal surfaces can help to further mitigate water condensation in oil when the engine cools down and active ventilation air is not available.

The cold start process of a turbocharged SI hydrogen engine was assumed to be 2 minutes idle at 600 rpm and 8 minutes engine operation at 1.5 bar intake pressure, 2500 rpm. The estimated water condensation during cold start process was 0.013 kg. The moisture condensed after the engine is turned-off was estimated to be 0.0005 kg by assuming that 80% of the moisture in crankcase will eventually condense to liquid water. The total water condensed in crankcase in each run was estimated as 0.0135 kg. The majority of the liquid water is condensed during the cold start process. The detailed process of estimating water condensation during cold start process is presented in Appendix III below.

The chance of an explosion in the crankcase can be mitigated by providing supplemental air which dilutes the concentration of H₂ below the low flammability limit. The mixing of non-saturated air (moisture partial pressure below the saturation pressure of water in ambient air at given temperature) with the blowby gas can dilute the water moisture in the crankcase and eliminate the condensation of moisture once the partial pressure of the moisture in the mixture is below the saturation pressure of water at given temperature during cold start or reduced temperature after engine shut-off. Accordingly, it is feasible to eliminate the explosion potential and mitigate the water condensation issues in the hydrogen engine crankcase by providing supplemental air through the active crankcase ventilation system. The lower the relative humidity, the more effective the ambient air is in mitigating the condensation of moisture of blowby gas in crankcase.

Water condensation can be eliminated when the moisture concentration is below that of the saturation pressure of water at given temperature. The mixing of fresh air which is usually not saturated will dilute the moisture in the blowby gas and mitigate water condensation issues if the moisture of the mixture of blowby gas and fresh air is below that of saturated water at a given temperature. Assuming fresh air at 25° C. and 60% relative humidity, the estimated fresh air flow rate is 5.0 times that of blowby gas flow rate. With the assumed blowby gas flow rate of 1% engine flow rate, the amount of fresh air needed for mitigating the condensation of water in crankcase is 5.0% of the engine gas (including air and hydrogen) flow rate. The detailed information estimating fresh air flow rate needed in eliminating water condensation in crankcase can be found in appendix IV below.

This estimation examined the composition of blowby gas from a turbocharged SI hydrogen engine operated on equivalence ratio of 0.5. The estimated composition of blowby gas is 9.51% H₂O, 8.68% H₂, 13.44% O₂, and 68.38% N₂.
The blowby gas entering the crankcase of a SI hydrogen engine operated on an equivalence ratio of 0.5 is combustible as the hydrogen concentration of 8.68% is well above the low flammability limit of hydrogen in air. The blowby gas in crankcase is explosive.
The dew point of the blowby gas with 9.51% moisture was 44.8° C. The moisture in blowby gas if cooled below 44.8° C. would condense, indicating the formation of liquid water in the crankcase of the SI hydrogen engine. The water condensation with the assumed 10 minutes cold start process was about 0.0135 kg for each cold start process.
The blending of the fresh air into the blowby gas through the active crankcase ventilation system can dilute the H₂ and moisture below the lean flammability limit and maximum moisture allowed, respectively. The explosion hazard and liquid water accumulation in the SI hydrogen engine crankcase can be eliminated.
The fresh air needed for eliminating crankcase explosion was about 1.17 times that of the blowby gas flow, and about 1.17% increase of the air consumed by this engine for combustion purposes. Such air can be recirculated to engine intake system through PCV valve.
The estimated flow rate of fresh air needed in eliminating the condensation of water in crankcase was 5.0 times that of blowby gas, and 5.0% of the air consumed by this engine for combustion purpose.

The estimated composition of the blowby gas from a SI hydrogen engine operating on ER=0.5 shows that the blowby gas is explosive and water will condense and accumulate in crankcase. Providing supplemental air to the crankcase can dilute the hydrogen and moisture in crankcase to below the lean flammability limit and the maximum moisture allowed at the engine operation temperature, respectively.

### Appendix I: Estimation of Blowby Gas Composition from SI Hydrogen Engine

Stoichiometric H₂-air mixture: H₂+0.5 (O₂+3.76N₂)=H₂O+1.88N₂ H₂-air mixture at equivalence ratio 0.5:0.5H₂+0.5 (O₂+3.76N₂)=H₂O+0.2502+1.88N₂ The composition of fresh mixture in cylinder prior to combustion:

$${X}_{H 2} = \frac{{n}_{H 2}}{{n}_{total}} = \frac{0.5}{0.5 + 0.5 ( 1 + 3.76 )} = 17.36 \%$$

$${X}_{O 2} = \frac{{n}_{O 2}}{{n}_{total}} = \frac{0.5}{0.5 + 0.5 ( 1 + 3.76 )} = 17.36 \%$$

$${X}_{N 2} = \frac{{n}_{N 2}}{{n}_{total}} = \frac{1.88}{0.5 + 0.5 ( 1 + 3.76 )} = 65.28 \%$$

The composition of fresh mixture in cylinder after combustion:

$${X}_{H 2 O} = \frac{{n}_{H 2 O}}{{n}_{total}} = \frac{0.5}{0.5 + 0.25 + 1.88} = 19.01 \%$$

$${X}_{O 2} = \frac{{n}_{O 2}}{{n}_{total}} = \frac{0.5}{0.5 + 0.25 + 1.88} = 9.51 \%$$

$${X}_{N 2} = \frac{{n}_{N 2}}{{n}_{total}} = \frac{1.88}{0.5 + 0.25 + 1.88} = 71.48 \%$$

The composition of the blowby gas estimated using 50% fresh unburnt mixture in cylinder and 50% combustion products.

$$\begin{matrix}{X}_{H 2 O , blowby} = {X}_{H 2 O , fresh} \times 0.5 + {X}_{H 2 O , comb} \times 0.5 \\ = 0 \times 0.5 + 19.01 \% \times 0.5 \\ = 9.51 \%\end{matrix}$$

$$\begin{matrix}{X}_{H 2 , blowby} = {X}_{H 2 , fresh} \times 0.5 + {X}_{H 2 , comb} \times 0.5 \\ = 17.36 \% \times 0.5 + 0 \% \times 0.5 \\ = 8.68 \%\end{matrix}$$

$$\begin{matrix}{X}_{O 2 , blowby} = {X}_{O 2 , fresh} \times 0.5 + {X}_{O 2 , comb} \times 0.5 \\ = 17.36 \% \times 0.5 + 9.51 \% \times 0.5 \\ = 13.44 \%\end{matrix}$$

$$\begin{matrix}{X}_{N 2 , blowby} = {X}_{N 2 , fresh} \times 0.5 + {X}_{N 2 , comb} \times 0.5 \\ = 65.28 \% \times 0.5 + 71.48 \% \times 0.5 \\ = 68.38 \%\end{matrix}$$

The composition of the fresh blow-by gas is: 9.51% H₂O, 8.68% H₂, 13.44% O₂, and 68.38% N₂.

### Appendix II Estimation of Fresh Air Needed for the Elimination of Explosion Hazard

The concentration of hydrogen in blowby gas is estimated as 8.68%, which is above the 4% lean flammability limit. The supplemental air needed for diluting hydrogen below 4% can be expressed as x times that of the blowby gas. x can be calculated using equation:

$$\frac{1 \times 8.68 \% + x \times 0 \%}{1 + x} = 4 \%$$

where x is the ratio of the flow rate of fresh air supplemented over that of the blowby gas. The x calculated is 1.17. The elimination of the explosion hazard in the crankcase of a SI hydrogen engine operating on ER=0.5 requires 1.17 times dilution air over the blowby gas.

### Appendix III Estimation of Water Condensation During Cold Start

The volume flow rate of engine intake gas during idle operation at 600 rpm and 40% charging efficiency:

$${idle}_{} = \frac{2 L}{1000} \times 0.4 \times \frac{600 rpm}{2} = 0.24 {m}^{3} / min$$

The volume flow rate of engine intake at 2500 rpm, 1.5 bar intake manifold pressure and 80% charging efficiency:

$${cruise}_{} = \frac{2 L \times 1.5}{1000} \times 0.8 \times \frac{2500 rpm}{2} = 3. {m}^{3} / min$$

The volume of blowby gas estimated by assuming 2 minutes idle and 8 minutes cruise operation at 1% blowby rate:

$${blowby}_{} = ( 0.24 \frac{{m}^{3}}{min} \times 2 min + 3. \frac{{m}^{3}}{min} \times 8 min ) \times 0.01 = 0.29 {m}^{3}$$

The moisture contained in the blowby gas during first 10 minutes engine operation at saturation temperature:

$${m}_{H 2 O , fresh blowdry} = \frac{0.0951 \times 100 kPa \times 0.29 m 3}{0.4615 \times 298 K} = 0.02 kg$$

Note: It is assumed as 1% of the volume flow rate of the intake air at standard (intake) condition. The temperature used as reference does not affect the results calculated. The moisture left in blowby gas at 25° C. saturated gas:

$${m}_{H 2 O , fresh blowdry at 25 ° C .} = \frac{0.0317 \times 100 kPa \times 0.29 m 3}{0.4615 \times 298 K} = 0.007 kg$$

The liquid water condensed in crankcase during the 10 minutes cold start process:

m_{H2O,condensed}=0.020−0.007=0.013 kg

The water condensed to liquid during the estimated 10-minute cold start process is 0.013 kg.

Appendix IV Estimation of Fresh Air Needed for the Mitigation of Water Condensation

The composition of the blowby gas is estimated as: 9.51% H₂O, 8.68% H₂, 13.44% O₂, and 68.38% N₂. The composition of air 25° C. and 60% relative humidity is 1.9% H₂O and 98.1% air. The flow rate of the supplemental air needed to dilute the moisture in crankcase to 3.17% can be calculated using equation:

$$\frac{1 \times 9.51 \% + x \times 1.9 \%}{1 + x} = 3.17 \%$$

Where x is the ratio of the flow rate of fresh air supplemented into crankcase over blowby gas needed for achieving the 3.17% moisture concentration in the blowby+fresh air mixture at 25° C. The x calculated is 5.0.

For the fresh air scenario assumed at 25° C. and 60% relative humidity, the minimum fresh ambient air needed for diluting the moisture in the mixture of blowby gas and fresh supplemental air to saturated mixture (without condensation) is 5.0 times that of blowby gas. It should be noted that the fresh air needed is affected by the temperature and relative humidity of the fresh ambient air. The higher the temperature of air and the lower the relative humidity, and the less the fresh dilution air needed for diluting the blowby gas to unsaturated mixture.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A combustion engine, comprising:
a crankcase comprising a combustion chamber;
a crankcase vent configured to vent crankcase gas from the crankcase; and
an active crankcase ventilation system configured to supply supplemental air to the crankcase, the crankcase gas comprising a mixture of blowby gas from the combustion chamber and the supplemental air in a ratio that reduces or eliminates condensation of water in the crankcase gas.

2. The combustion engine of claim 1, wherein the combustion engine is a hydrogen engine.

3. The combustion engine of claim 1, wherein the combustion engine is a natural aspirated engine where air provided to the combustion chamber is enabled by induction of piston motion.

4. The combustion engine of claim 1, wherein the combustion engine comprises a compressor configured to supply compressed air to the combustion chamber.

5. The combustion engine of claim 4, wherein the active crankcase ventilation system comprises a supplemental ventilation supply system configured to supply a portion of the compressed air from the compressor to the crankcase as the supplemental air.

6. The combustion engine of claim 5, wherein the supplemental ventilation supply system comprises a control valve configured to control flow of the supplemental air to the crankcase.

7. The combustion engine of claim 6, comprising an engine electronic control unit (ECU) configured to control operation of the control valve based upon monitored engine parameters.

8. The combustion engine of claim 7, wherein the engine ECU adjusts the control valve in response to a change in the monitored engine parameters.

9. The combustion engine of claim 8, wherein the monitored engine parameters include equivalence ratio, ambient air temperature, relative humidity, or a combination thereof.

10. The combustion engine of claim 1, wherein the active crankcase ventilation system comprises a supplemental air supply system comprising an air pump configured to supply the supplemental air to the crankcase.

11. The combustion engine of claim 10, wherein the supplemental air supply system comprises a control valve configured to control flow of the supplemental air to the crankcase.

12. The combustion engine of claim 11, wherein the control valve or the air pump is adjusted in response to a change in monitored engine parameters.

13. The combustion engine of claim 12, wherein operation of the air pump is initiated in response to inlet pressure of the combustion chamber falling below a pressure threshold.

14. The combustion engine of claim 13, wherein the pressure threshold is determined by an engine electronic control unit (ECU) based at least in part upon the monitored engine parameters.

15. The combustion engine of claim 1, comprising a passive moisture absorption coating disposed on a wall of the crankcase, the passive moisture absorption coating comprising a high porosity ceramic material.

16. The combustion engine of claim 15, wherein the high porosity ceramic material comprises silica aerogel, ceramic foam, a zirconia-based ceramic coating, or an alumina-based ceramic coating.

17. The combustion engine of claim 15, wherein the passive moisture absorption coating comprises a bonding layer between the wall of the crankcase and the high porosity ceramic material.

18. The combustion engine of claim 17, wherein the bonding layer comprises aluminum or a composite magnesium aluminum alloy.

19. The combustion engine of claim 1, wherein the crankcase vent comprises a positive crankcase ventilation (PCV) valve configured to control venting of the crankcase gas.

20. The combustion engine of claim 19, wherein the crankcase vent comprises an oil separator configured to separate oil from the crankcase gas prior to venting, wherein the separated oil returned to the crankcase.
